(19) United States
(12) Patent Application Publication
(10) Pub. No.: US 2013/0071696 A1
(43) Pub. Date: Mar. 21, 2013

(54) POUCH-TYPE BATTERY WITH IMPROVED SAFETY BY COATING SEALING UNIT WITH FLAME RETARDANT AND HEAT RESISTANT RESIN COMPOSITION PREPARED BY MIXING FLAME RETARDANT MATERIAL AND HEAT RESISTANT MATERIAL TO THERMOPLASTIC RESIN OR THERMOSETTING RESIN AND PRODUCTION METHOD THEREOF

(71) Applicants: Chi-Su Kim, Seoul (KR); Heon-Young Lee, Cheonan-si (KR); Myung-Hun Cho, Anseong-si (KR); Seog-Bum Kang, Anseong-si (KR)

(72) Inventors: Chi-Su Kim, Seoul (KR); Heon-Young Lee, Cheonan-si (KR); Myung-Hun Cho, Anseong-si (KR); Seog-Bum Kang, Anseong-si (KR)

(73) Assignee: EIG LTD., Cheonan-city, Chungcheongnam-do (KR)

(21) Appl. No.: 13/509,717

(22) PCT Filed: Nov. 18, 2010
(86) PCT No.: PCT/KR2010/008140

§ 371 Date: May 14, 2012

(30) Foreign Application Priority Data
Nov. 20, 2009 (KR) 10-2009-0112371

(51) Int. Cl. H01M 2/02; H01M 10/42; H01M 2/30

(52) U.S. Cl. CPC H01M 2/0257; H01M 2/30; H01M 10/4257
USPC 429/7; 429/163; 429/179; 429/156; 429/158

(57) ABSTRACT

The present invention relates to a pouch-type lithium secondary battery comprising: an electrode assembly which includes an anode, a separator, and a cathode; and a pouch which has a groove for accommodating the electrode assembly and an edge of which the upper and lower parts are formed in a flange type by being bonded around the groove, wherein in at least a part of the edge that is formed in the flange type, an end of the edge is covered by a flame retardant and heat resistant resin composition wherein a flame retardant material and a heat resistant material are mixed to a thermoplastic resin or a thermosetting resin, thereby improving safety.

### FIELD OF THE INVENTION

This application is based upon and claims the benefit of priority from Korean Patent Applications No. 10-2009-0112371, filed Nov. 20, 2009, the entire content of which is incorporated herein by reference.

The present invention relates to a lithium secondary battery, and more specifically, to a pouch-type lithium secondary battery wherein an electrode assembly including an anode, a cathode and a separator is accommodated in a pouch.

### BACKGROUND OF THE INVENTION

As increased technical development and demand for mobile devices, demand for batteries as an energy source keeps on growing, and accordingly, many studies for batteries responding to various demands are going on.

Representatively, in respect of battery shape, demands for thin square-shaped secondary batteries and pouch-type secondary batteries, which can be applied to products such as a mobile phone, are high, and in respect of material, demands for lithium secondary battery such as lithium ion battery, lithium ion polymer battery and the like, which have advantages of high energy density, discharge voltage, output stability and the like, are high.

Further, the secondary battery may be classified according to the structure of the electrode assembly having anode/separator/cathode structure, and representatively, the electrode assembly may be a jelly-roll (winding-type) electrode assembly, wherein long sheet-type anodes and cathodes with separators interposed therebetween are wound; a stack-type electrode assembly, wherein pluralities of anodes and cathodes cut by certain size unit are sequentially laminated with separators interposed therebetween; and a stack/folding-type electrode assembly formed by winding Bi-cells or Full cells, wherein certain unit of anodes and cathodes are laminated with separators interposed therebetween.

Recently, a pouch-type battery, wherein the stack-type or the stack/folding-type electrode assembly is built in a pouch-type battery case of aluminum laminate sheet, is receiving a lot of attention due to its low cost, small weight, easy reshaping and the like, and its demand is gradually growing.

FIG. 1 is an exploded perspective view of a general structure of a conventional representative pouch-type secondary battery. Referring to FIG. 1, a pouch-type secondary battery 10 comprises an electrode assembly 30, an electrode taps 31, 32 extended from the electrode assembly 30, electrode leads 40, 41 welded to the electrode taps 31, 32, and a battery case 20 accommodating the electrode assembly 30. The electrode assembly 30 is an electricity generating device wherein anodes and cathodes are laminated sequentially with interposed separators, and has a stack-type or stack/folding-type structure. The electrode taps 31, 32 are extended from each electrode plates of the electrode assembly 30. The electrode leads 40, 41 are electrically connected with a plurality of the electrode taps 31, 32 extended from each electrode plates, for example, by welding, respectively, and parts thereof are exposed outside of the battery case 20. Further, insulating films 50 are attached to a part of the upper and lower faces of the electrode leads 40, 41 in order to increase the degree of seal with the battery case 20 and at the same time to secure electrically insulated state.

The battery case 20 comprises: a case body 22 including a concave shaped receiving unit 33 where the electrode assembly 30 is settled; and a cover 21 united to the body 22, and the both sides 24 and the upper end 25 of the body and the cover as a contact site are bonded each other, while accommodating the electrode assembly 30 to the receiving unit 33, to complete a battery. Because the battery case 20 has an aluminum laminate structure of resin layer/metal foil layer/resin layer, the cover 21, and both sides 24 and the upper end 25 of the body 22 are bonded by fusing the resin layers together by applying heat and pressure to their contacting regions. The both sides 24 can be uniformly sealed because identical resin layers of the upper and lower battery cases 20 are directly contacted. On the other hand, because the electrode leads 40, 41 are projected at the upper end 25, the fusion is conducted with insulating films 50 interposed between the electrode lead 40, 41 and the cases to increase sealability in consideration of heterogeneity between the thickness of the electrode leads 40, 41 and the material of the battery case 20.

In order to form the pouch-type lithium secondary battery, first of all, the electrode assembly formed by laminating the anode, the separator and the cathode or winding after laminating is located inside the temporarily sealed pouch. And, the upper and lower pouch films at the open edge part of the pouch are heated and fused to prepare a sealed pouch-type bare cell battery. The pouch used for the pouch-type battery is generally composed of a multi-layer of a metal foil layer and a synthetic resin layer covering thereof, and the battery using the pouch can be much lighter than the battery using a metal can. As the metal forming the foil of the multi-layer pouch, aluminum is generally used. A polymer film forming the inner layer of the pouch film protects the metal foil from electrolytes and prevents shorts between the cathode and anode, and between electrode taps. However, if there is no special insulating work at the edge end of the pouch, small part of the metal foil forming the middle layer of the pouch film is exposed. Therefore, even when the edges of both sides are folded and protective circuit substrates are attached to the electrode taps in order to form a core pack battery in a bare cell state, the metal foil is still exposed at the edge end of the pouch.

In the state of exposure of the metal foil, when the core pack battery is directly charged into a hard case or battery box of a product, the metal foil of the pouch film may be connected with a cathode through other conductor of the circuit unit in the hard case or the battery box. Or, the electrical connect may be formed by a route through the metal foil of the pouch film, the conductor of the protective circuit substrate, the conductor of the hard case or the battery box and the cathode. At any case, aluminum of the metal foil of the pouch film may be directly or indirectly connected with a copper tap or collector of the cathode, and the aluminum foil of the pouch film may be corroded by electrochemical reaction, and particularly, the corrosion may be accelerated when the cathode tap is exposed to the leaked electrolyte ingredients or moist environment in the pouch.

If the aluminum foil acting as a barrier of moisture and oxygen is continuously corroded, the polymer layer of the pouch film is not enough to block the inflow of the moisture and oxygen. If the blocking ability of the pouch becomes lower, the battery may not work properly. Namely, when an organic electrolyte solution of an electrolyte separator is evaporated or exterior moisture or oxygen is introduced thereinto, abnormal phenomenon such as swelling may occur in the pouch, and it may cause disuse of the battery, performance degradation and life time reduction.

As a method to prevent these problems, a method of folding the edge formed in a flange type two times at both right and left sides of the core pack battery was suggested. As shown in FIG. 2, when a half of the edges 23 of both sides of the pouch is folded once to overlap the edge 23 parts, the width of the edges 23 becomes half, and the edge ends 231 are contacted to the side wall face 541 forming a groove 54. And, the overlapped edges are folded again to the groove 54 direction. As a result, as shown in FIG. 3, the edge end 231 becomes to be inserted between the edge 23 and the side wall face 541 of the groove so as not to be externally visible. However, when electrode taps 37, 38 are bent, a region where the protective circuit substrate (not illustrated) connected to the electrode taps is located is an empty space not occupied by the groove 54 of the pouch. Therefore, when the edges 23 are folded two times, the edge ends 231 are not covered by the side wall face 541 forming the groove 54. Because the edge ends 231 are still exposed in this space, it may probably become electrically connected with the protective circuit substrate and the like located herein.

On the other hand, as a unit cell (battery cell) of a middle or large-sized battery pack, a nickel-hydrogen secondary battery has been generally used, but recently, lithium secondary batteries providing high output over capacity like in a small battery packs being studied, and some of them are already in the commercialization stage. However, the lithium secondary battery has a problem of low safety basically. In the middle or large-sized battery pack, one of major causes of the abnormal operation is an electrical short. The pouch-type battery is a favored candidate as a unit cell of the middle or large-sized battery pack due to its many merits, but it has problems of low mechanical rigid of the battery case and high risk of fire when the aluminum foil is exposed as described above. In the middle or large-sized battery pack wherein many unit cells are electrically connected for high output and large capacity, the fire is very serious risk factor hampering the safety.

Therefore, a pouch-type secondary battery, which can solve the said problems, and prevent an electrical short between a pouch metal foil and a cathode and battery trouble caused by corrosion of the metal foil, is needed. Accordingly, in order to make up for the problems of the existing techniques, when producing a pouch-type lithium secondary battery comprising a pouch, which has a groove for accommodating an electrode assembly and an edge formed in a flange type by being bonded around the groove, an end of the edge is coated with a flame retardant material and a heat resistant material.

### SUMMARY OF THE INVENTION

Accordingly, it is an object of the present invention to provide a pouch-type lithium secondary battery with improved safety, which can prevent an edge end of the pouch where a metal foil forming one layer of a multi-layer pouch film is exposed from being electrically connected with other metals forming an electrode through a protective circuit substrate and conductors in a hard case as well as reduce the risk of fire caused by a short.

Further, it is another object of the present invention to provide a middle or large-sized battery pack comprising the said secondary batteries as a unit cell.

In order to accomplish one object of the present invention, the present invention provides a pouch-type lithium secondary battery with improved safety comprising: an electrode assembly which includes an anode, a separator and a cathode; and a pouch which has a groove for accommodating the electrode assembly and an edge formed in a flange type by being bonded around the groove, wherein in at least a part of the edge formed in the flange type, an end of the edge is covered by a flame retardant and heat resistant resin composition prepared by mixing a flame retardant material and a heat resistant material to a thermoplastic resin or a thermosetting resin.

It is a feature of some implementations that the flame retardant and heat resistant resin composition prepared by mixing the flame retardant material and the heat resistant material to the thermoplastic resin or the thermosetting resin is formed to cover the entire end of the edge except for parts where electrode taps installed on the anode and the cathode are extracted in the pouch.

In the present invention, the flame retardant and heat resistant resin composition prepared by mixing the flame retardant material and the heat resistant material to the thermoplastic resin or the thermosetting resin is characterized by forming a flame retardant and heat resistant tape.

It is a feature of some implementations that the pouch forms a square when viewed from the thickness direction of the groove; the edges of the both two sides of the pouch are bent one time to the groove-formed direction; and a half width of the flame retardant and heat resistant tape made up of the flame retardant and heat resistant resin composition prepared by mixing the flame retardant material and the heat resistant material to the thermoplastic resin or the thermosetting resin is attached to the edge along the end of the edge, and the other half width of the tape is attached to the face forming the groove.

It is a feature of some implementations that the pouch forms a square when viewed from the thickness direction of the groove; the edges of the both two sides of the pouch are primarily bent in half width to be overlapped each other; the overlapped edges are secondarily bent again to the groove direction; and the flame retardant and heat resistant resin composition prepared by mixing the flame retardant material and the heat resistant material to the thermoplastic resin or the thermosetting resin covers one side where a protective circuit substrate is installed and only the edge end of the two edge where the two sides meet.

It is a feature of some implementations that the flame retardant material is one or a mixture of more than two selected from a group consisting of halogen-based flame retardant, phosphorous-based flame retardant, nitrogen-based flame retardant and inorganic compound flame retardant.

It is a feature of some implementations that the halogen-based flame retardant is one or a mixture of more than two selected from a group consisting of tribromophenoxyethane, tetrabromobisphenol-A (TBBA), octabromodiphenylether (OBDPE), brominated expoxy, brominated polycarbonate oligomer, chlorinated paraffin, chlorinated polyethylene and cycloaliphatic chlorinated flame retardant.

It is a feature of some implementations that the phosphorous-based flame retardant is one or a mixture of more than two selected from a group consisting of phosphates such as red phosphor, ammonium phosphate, phosphine oxide, phosphine oxide diols, phosphites, phosphonates, triarylphosphate, alkyldiarylphosphate, trialkylphosphate and resorcinol bis(diphenylphosphate) (RDP).

It is a feature of some implementations that the nitrogen-based flame retardant is one or a mixture of more than two selected from a group consisting of melamine, melamine phosphate and melamine cyanurate.

It is a feature of some implementations that the inorganic compound flame retardant is one or a mixture of more than two selected from a group consisting of aluminum hydroxide, magnesium hydroxide, antimony oxide, tin hydroxide, tin oxide, molybdenum oxide, zirconium compound, borate and calcium salt.

It is a feature of some implementations that the heat resistant material is copper-based heat resistant or phosphite-based heat resistant.

It is a feature of some implementations that the phosphite-based heat resistant is selected from a group consisting of bis(2,6-di-tert-butyl-4-methylphenyl)pentaerythritol-di-phosphite, tetrakis[methylene-3-(laurylthio)propionate]methane, triphenylphosphite, trilaurylphosphite, tris(nonylphenyl)phosphite, tri-iso-octyl-phosphite, trioleylphosphite, tris(2,4-di-tert-butylphenyl)phosphite, diphenyl-nonylphenyl-phosphite, phenyl-di-isodecyl-phosphite and trilauryl-tri-thio-phosphite.

It is a feature of some implementations that the secondary battery is a lithium ion battery or a lithium polymer battery.

In order to accomplish another object of the present invention, the present invention provides a middle or large-sized battery pack comprising one or more than two of the pouch-type lithium secondary batteries.

It is a feature of some implementations that in the battery pack, at least a part of or entire unit cells is connected in series, and one or more than two of the unit cells connected in series is composed of the pouch-type lithium secondary battery.

### Advantageous Effects of the Invention

According to the present invention, in the production of a pouch-type lithium secondary battery comprising a pouch which has a groove for accommodating the electrode assembly and an edge formed in a flange type by being bonded around the groove, an electrical short between a pouch metal foil and a cathode of the battery, and abnormality of the battery by the corrosion of the metal foil can be prevented by coating an end of the edge with a flame retardant material and a heat resistant material.

### BRIEF DESCRIPTION OF DRAWINGS

The above and other objects and features of the present invention will become apparent from the following description of the invention taken in conjunction with the following accompanying drawings, which respectively show:

FIG. 1: an exploded perspective view of a general structure of a conventional representative pouch-type secondary battery;

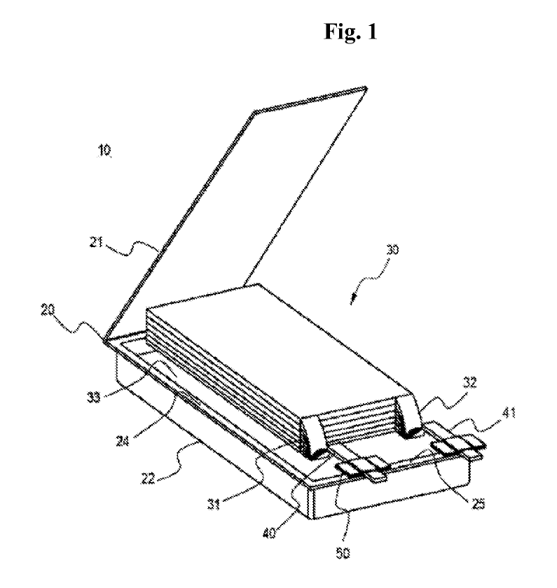

FIG. 2: a view showing a method to fold an edge formed in a flange type one time at right and left sides of a pouch;

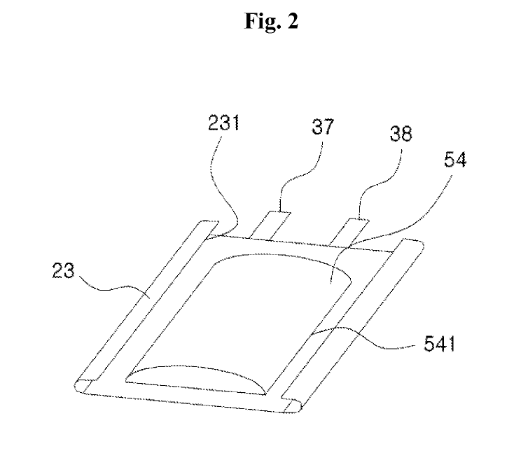

FIG. 3: a view showing a method to fold an edge formed in a flange type two times at right and left sides of a pouch;

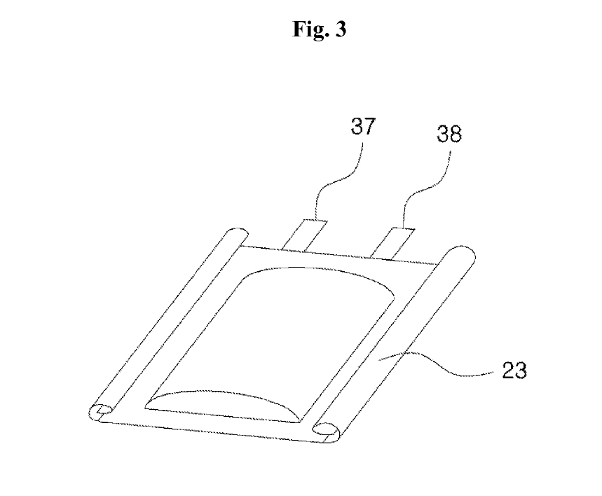

FIG. 4: a schematic perspective view of the lithium secondary battery according to one embodiment of the present invention showing covering an edge formed in a flange type at right and left sides of a pouch with a resin composition comprising flame retardant and heat resistant materials;

FIG. 5: a schematic perspective view of the lithium secondary battery according to one embodiment of the present invention showing covering an edge formed in a flange type at right and left sides of a pouch with a resin composition comprising flame retardant and heat resistant materials after folding the edge one time; and

FIG. 6: a schematic perspective view of the lithium secondary battery according to another embodiment of the present invention showing covering an edge formed in a flange type at right and left sides of a pouch with a resin composition comprising flame retardant and heat resistant materials after folding the edge two times.

### DESCRIPTION OF SYMBOLS

23: edge
37, 38: Electrode taps
54: groove
231: edge end

### DETAILED DESCRIPTION OF THE INVENTION

Hereinafter, the present invention will be described in detail

The pouch-type lithium secondary battery to accomplish the object of the present invention is characterized that, in a pouch-type lithium secondary battery comprising: an electrode assembly which includes an anode, a separator and a cathode; and a pouch which has a groove for accommodating the electrode assembly and an edge of which upper and lower parts are formed in a flange type by being bonded around the groove, an end of the edge in at least a part of the edge is covered by a flame retardant and heat resistant resin composition prepared by mixing a flame retardant material and a heat resistant material to a thermoplastic resin or a thermosetting resin.

In the present invention, the flame retardant and heat resistant resin composition may form a fire retardant coating composition and cover the entire end of the edge except for parts where an electrode taps are extracted, and may form an adhesive tape such as a flame retardant and heat resistant tape.

In the present invention, the pouch forms approximately a square when viewed from the thickness direction of the groove or when viewed without regarding the groove thickness, and the edges of the both two sides of the pouch are bent to the groove-formed direction. When the flame retardant and heat resistant resin composition prepared by mixing the flame retardant material and the heat resistant material to the thermoplastic resin or the thermosetting resin forms an adhesive tape and is attached thereto, a half width of the flame retardant and heat resistant tape made up of the flame retardant and heat resistant resin composition is attached to the edge along the end of the edge, and the other half width of the tape is attached to the bottom face or side wall face of the groove so as to cover the edge end as well as to stick the bent edge to the pouch groove.

The fire-retardant coating inhibits spreading of a flame to an inflammable material by carefully surrounding the surface of the inflammable material. The inventive flame retardant and heat resistant resin composition for forming the fire-retardant coating is a composition used to form the fire-retardant coating on the surface of the pouch.

The flame retardant and heat resistant resin composition of the present invention is a composition prepared by mixing the flame retardant material and the heat resistant material to the thermoplastic resin or the thermosetting resin. Hereinafter, unless particularly limited, the flame retardant and heat resistant resin composition of the present invention gives a general name to a resin composition, which uses any one of the thermoplastic resin and the thermosetting resin as a matrix

The thermoplastic resin used in the present invention may be any conventional resin, for example, polyethylene, polypropylene, polyisoprene, polyester (polyethyleneterephthalate, polybutyleneterephthalate and the like), polybutadiene, styrene resin, impact resistant polystyrene, acrylonitrile-styrene resin (AS resin), acrylonitrile-butadiene-styrene resin (ABS resin), methylmetacrylate-butadiene-styrene resin (MBS resin), methylmethacrylate-acrylonitrile-butadiene-styrene resin (MABS resin), acrylonitrile-acryl rubber-styrene resin (AAS resin), polymethyl(meth)acrylate, polycarbonate, modified polyphenylene ether (PPE), polyamide, polyphenylene sulfide, polyimide, polyether ether ketone, polysulfone, polyarylate, polyether ketone, polyether nitrile, polythioether sulfone, polyether sulfone, polybenzimidazole, polycarbodiimide, polyamideimide, polyether imide, lquid crystal polymer, plastic composite and the like.

Among these thermoplastic resins, one or a mixture of more than two selected from polyester, ABS resin, polycarbonate, modified polyphenylene ether, polyamide and the like can be used preferably.

In the present invention, the thermosetting resin may be any of known resin, and preferably, it may be polyurethane, phenol resin, melamine resin, urea resin, unsaturated polyester resin, diallylphthalate resin, silicon resin, epoxy resin and the like. Among these thermosetting resins, polyurethane, phenol resin, melamine resin, epoxy resin and the like are more preferable.

As the epoxy resin, any known epoxy resin, for example, bisphenol-A type epoxy resin, bisphenol-F type epoxy resin, bisphenol-AD type epoxy resin, phenol novolac-type epoxy resin, cresol novolac-type epoxy resin, cycloaliphatic epoxy resin, glycidylester-based resin, glycidylamine-based epoxy resin, heterocyclic epoxy resin, urethane-modified epoxy resin, brominated bisphenol-A type epoxy resin and the like can be used without limitation.

In these days, a flame retardant material (FR) market is composed of products preventing the combustion process with chemical and/or physical means. Mechanically, theses flame retardants are proposed to act during combustion of products having gas-phase, condensed-phase or both phases. In at least a part of the edge, when the edge end is covered with the flame retardant material and heat resistant material, it blocks the danger of fire or explosion resulted from a short in a battery or other causes. Further, in the present invention, the flame retardant material and the heat resistant material do not affect to the chemical reaction in the battery and lithium ion conductivity by adding them into the battery case instead of adding them inside the battery, and therefore, the performance degradation of the battery can be prevented.

Specific kinds of the flame retardant are not particularly limited, and for example, it may be halogen-based flame retardant, phosphorous-based flame retardant, nitrogen-based flame retardant and inorganic compound flame retardant. According to circumstances, it may be one or a mixture of more than two of them. Recently, due to the environmental problems, the use of halogen-based flame retardants is tending to be regulated and the use of non halogen-based flame retardants is tending to be recommended. Particularly, in the automobile industry, the environmental problems are regarded as important. Now, the non halogen-based flame retardants used in this technological area are inorganic oxide, nitrogen-based flame retardant, phosphorous-based flame retardant and the like.

The halogen-based flame retardant generally displays flame retardant effect by practically stabilizing radicals generated from gas-phase. The halogen-based flame retardant may be tribromophenoxyethane, tetrabromobisphenol-A (TBBA), octabromodiphenylether (OBDPE), brominated expoxy, brominated polycarbonate oligomer, chlorinated paraffin, chlorinated polyethylene, cycloaliphatic chlorinated flame retardant and the like.

The phosphorous-based flame retardant generally displays flame retardant effect by a protective layer formed poly-meta-phosphoric acid generated by pyrolysis or by blocking oxygen through a carbon coat generated by dehydration during poly-meta-phosphoric acid production. The phosphorous-based flame retardant may be phosphates such as red phosphor, ammonium phosphate and the like, phosphine oxide, phosphine oxide diols, phosphites, phosphonates, triarylphosphate, alkyldiaryl phosphate, trialkyl phosphate, resorcinaol bisdiphenyl phosphate (RDP) and the like.

The nitrogen-based flame retardant may be melamine, melamine phosphate, melamine cyanurate and the like, preferably melamine cyanurate.

The inorganic compound flame retardant generally displays flame retardant effect. It releases incombustible gas such as H₂O, carbon dioxide, sulfur dioxide, hydrogen chloride and the like by pyrolysis and induces an endothermic reaction, and therefore, it prevents oxygen access by diluting combustible gas and reduces the production of cooling and pyrolysis products by an endothermic reaction. The inorganic compound flame retardant may be aluminum hydroxide, magnesium hydroxide, antimony oxide, tin hydroxide, tin oxide, molybdenum oxide, zirconium compound, borate, calcium salt and the like.

Most preferably, the flame retardant may be ammonium phosphate-based flame retardant.

According to circumstances, the flame retardants exemplified above may be mixed, and additives inducing synergistic effect of the flame retardant may be further added thereto.

Further, the present invention may comprise copper-based heat resistant to give heat resistant characteristic, and a surface-treated copper compound may be used.

In addition, in the present invention, a phosphite-based heat resistant having synergistic effect of a long-term heat resistant may be further added together with the copper-based heat resistant to strengthen the long-term heat resistant characteristic. The phosphite-based heat resistant may be selected from a group consisting of bis(2,6-di-tert-butyl-4-methylphenyl)pentaerythritol-di-phosphite, tetrakis[methylene-3-(laurylthio)propionate]methane, triphenylphosphite, trilaurylphosphite, tris(nonylphenyl)phosphite, tri-iso-octyl-phosphite, trioleylphosphite, tris(2,4-di-tert-butylphenyl)phosphite, diphenyl-nonylphenyl-phosphite, phenyl-di-isodecyl-phosphite, trilauryl-tri-thio-phosphite and the like. Among these, bis(2,6-di-tert-butyl-4-methylphenyl)pentaerythritol-di-phosphite are preferred.

In the present invention, the thermosetting resin may be used as one or a mixture of more than two. Traditionally, the mixing ratio of the flame retardant to the thermoplastic resin or the thermosetting resin may be 0.1 to 90 parts by weight, preferably 1 to 50 parts by weight, more preferably 5 to 30 parts by weight, based on 100 parts by weight of the thermoplastic resin or the thermosetting resin, but not limited thereto. The improved flame resistant characteristic may be secured with the amount ranging from 5 parts by weight to 30 parts by weight. Further, the mixing ration of the heat resistant to the thermoplastic resin or the thermosetting resin may be 0.1 to 90 parts by weight, preferably 1 to 50 parts by weight, more preferably 5 to 30 parts by weight, and the improved heat resistant characteristic may be secured with the amount ranging from 5 parts by weight to 30 parts by weight.

Inorganic filler may be combined to the flame retardant and heat resistant resin composition of the present invention for further enhanced anti-dripping effect. When the flame retardant and heat resistant and the inorganic filler are coexisting in the resin, the resin surface layer becomes denser and more rigid, and therefore, it inhibits diffusion of the produced gas on the resin surface. Further, it may displays excellent flame retardant effect by stimulating the formation of a char layer of the flame retardant.

As the inorganic filler, mica, kaolin, talc, silica, clay, barium sulfate, barium carbonate, calcium carbonate, calcium sulfate, calcium silicate, titanium oxide, glass bid, glass balloon, glass flake, glass fiber, fibrous alkali metal titanate (such as potassium titanate fiber), fibrous transition metal salt borate (such as aluminum borate fiber), fibrous alkaline earth metal salt borate (such as magnesium borate fiber), zinc oxide whisker, titanium oxide whisker, magnesium oxide whisker, selenite whisker, aluminum silicate (mineral name: mullite) whisker, calcium silicate (mineral name: wollastonite) whisker, silicon carbide whisker, titanium carbide whisker, silicon nitride whisker, titanium nitride whisker, carbon fiber, alumina fiber, alumina-silica fiber, zirconia fiber or quartz fiber may be selected. Among theses, the inorganic filler having shape anisotropy such as whiskers and mica may be selected preferably. Further, the inorganic filler may be used as one or a mixture of more than two.

Typically, in terms of balance between the mechanical properties and the flame retardant performance, the mixing ratio of the inorganic filler to the thermoplastic resin or the thermosetting resin may be 0.01 to 50 parts by weight, preferably 1 to 20 parts by weight based on 100 parts by weight of the thermoplastic resin or the thermosetting resin.

Hereinafter, the present invention will be described in detail through the embodiments of the present invention with reference to the accompanying drawings.

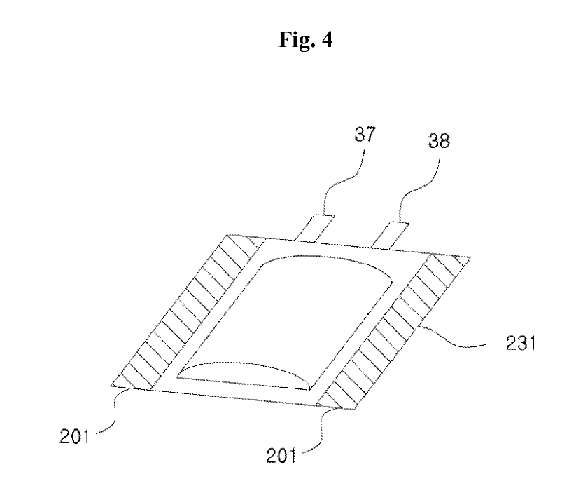

FIG. 4 shows the lithium secondary battery produced according to one embodiment of the present invention. Looking at the method forming the state of FIG. 4, the upper and lower parts of the pouch may be formed by folding the middle of the rectangular pouch film generally formed in one based on the longitudinal direction of one side. On the bottom thereof, a groove accommodating the electrode assembly may be formed by press processing and the like. At this time, the pouch film may generally have multi-layer structure formed by coating a polymer film such as polypropylene resin on or underneath of the aluminum foil. Meanwhile, in another embodiment, the anode and the cathode, and the anode and the cathode taps may be arranged by varying polarity. When the edge around the lower groove where the electrode assembly is settled and the upper edge of the pouch film responding thereto are closely attached each other, and the attached part is heated and pressed, the inner polymer films are fused and then the pouch is sealed so as to form a bare cell battery. At this time, the edges 23, 23′ may form in a flange type on at least three sides of four sides around the groove 54 as the upper and lower pouch films are fused.

Ignoring the thickness of the groove 54, in the pouch approximately forming a square, the heat retardant and heat resistant tape 201 composed of the flame retardant and heat resistant resin composition prepared by mixing the flame retardant material and the heat resistant material to the thermoplastic resin or the thermosetting resin is attached to the ends of the edges 23 along the side where the electrode taps 37, 38 are withdrawn and both sides connected thereto in order not to expose the metal foil of the end. And, edges 23 of two sides are bent to the groove-formed direction. The core pack battery may be formed by attaching a structure body such as a protective circuit substrate 51, PTC (positive temperature coefficient) and the like to the anode tap and cathode tap 37, 38 of the bare cell battery as usual.

At this time, the conductive unit of the protective circuit substrate 51 still lies closely to the edges 23 of both sides of the folded pouch. However, because the metal foil is blocked by the heat retardant and heat resistant tape 201 composed of the flame retardant and heat resistant resin composition prepared by mixing the flame retardant material and the heat resistant material to the thermoplastic resin or the thermosetting resin at the ends of the edges 23, there is no worry about electrically connecting of the conduction part of the protective circuit substrate 51 with the metal foil. Further, when the core pack battery is combined into a hard case later, the heat retardant and heat resistant tape 201 blocks the electrical connect of the pouch metal foil with the conductive unit at the ends of the folded edges 23 of the pouch even when having a separate conductive unit of a sub-circuit inside the hard case. Therefore, there is no worry about corrosion of the pouch metal foil because the foil is cut off from the cathode through the conductive unit inside the hard case.

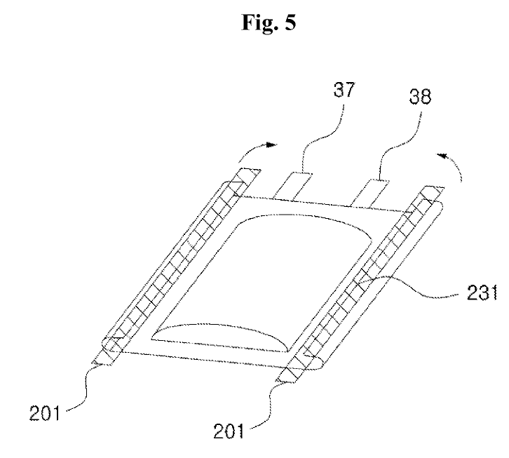

FIG. 5 is a front view schematically representing the core pack battery according to another embodiment of the present invention. As shown in FIG. 5, unlike FIG. 4, taping to the edges 23 of both sides of the pouch is conducted after folding the edges. And, a half width of the tape 203 is attached to the edge along the end of the edge 23, and the other half of the tape is attached to the face forming the groove 54 or a part of the bottom face of the pouch. Therefore, the tape 203 prevents the exposed metal foil of the end of the edge 23 from contacting to other conductor parts, and at the same time, forms coordinated finish in appearance so as to closely attach the bent edge 23 to the groove 54. At this time, a problem that the bent edge causes inconveniences on post-processes such as putting the core pack battery in the hard case can be solved.

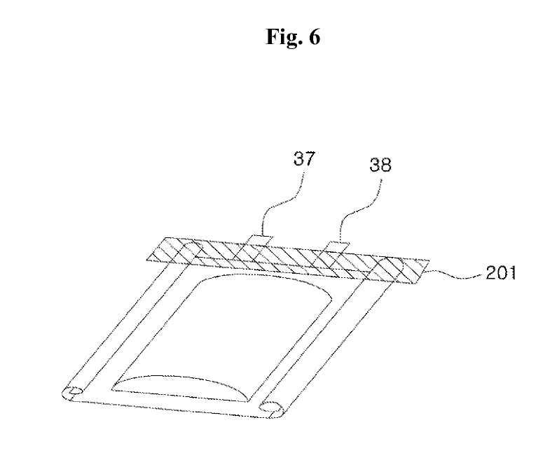

FIG. 6 is a schematic perspective view of the core pack battery according to another embodiment of the present invention. As shown in FIG. 6, the edges 23 of both sides of the pouch are folded two times. Therefore, the metal foils of the edge ends 231 are not exposed at the groove 54—formed part A along both sides of the pouch. However, at a region limiting space where the protective circuit substrate 51 in the core pack battery locates, namely, at two upper edge parts B of the pouch, the ends 231 of the right and left edges 23 of the pouch are covered by the heat retardant and heat resistant tape 205 composed of the flame retardant and heat resistant resin composition prepared by mixing the flame retardant material and the heat resistant material to the thermoplastic resin or the thermosetting resin. Therefore, there is no worry about an electric short between the pouch metal foil and the conductive unit of the protective circuit substrate even when the conductive unit of the protective circuit substrate 51 is closely located to the right and left edge ends 231 of the pouch. In this embodiment, the taping work may become more simple than the case of other embodiment taping the flame retardant and heat resistant tape long because the edge ends 231 are not exposed at most of the right and left edges of the pouch, and the flame retardant and heat resistant tape 205 is attached to only two upper edges of the pouch where the ends are exposed.

### INDUSTRIAL APPLICABILITY

The present invention can be used as a pouch-type lithium secondary battery having improved safety by covering an end of the edge in at least a part of the edge with a flame retardant and heat resistant resin composition prepared by mixing a flame retardant material and a heat resistant material to a thermoplastic resin or a thermosetting resin.

While the invention has been described with respect to the above specific embodiments, it should be recognized that various modifications and changes may be made and also fall within the scope of the invention as defined by the claims that follow.

1. A pouch-type lithium secondary battery with improved safety comprising: an electrode assembly which includes an anode, a separator and a cathode; and a pouch which has a groove for accommodating the electrode assembly and an edge formed in a flange type by being bonded around the groove, wherein in at least a part of the edge, an end of the edge is covered by a flame retardant and heat resistant resin composition prepared by mixing a flame retardant material and a heat resistant material to a thermoplastic resin or a thermosetting resin.

2. The pouch-type lithium secondary battery with improved safety of claim 1, wherein the flame retardant and heat resistant resin composition prepared by mixing the flame retardant material and the heat resistant material to the thermoplastic resin or the thermosetting resin is formed to cover the entire end of the edge except for parts where electrode taps installed on the anode and the cathode are extracted in the pouch.

3. The pouch-type lithium secondary battery with improved safety of claim 1, wherein the flame retardant and heat resistant resin composition prepared by mixing the flame retardant material and the heat resistant material to the thermoplastic resin or the thermosetting resin is formed to a flame retardant and heat resistant tape.

4. The pouch-type lithium secondary battery with improved safety of claim 1, wherein the pouch forms a square when viewed from the thickness direction of the groove; the edges of the both two sides of the pouch are bent one time to the groove-formed direction; and a half width of the flame retardant and heat resistant tape made up of the flame retardant and heat resistant resin composition prepared by mixing the flame retardant material and the heat resistant material to the thermoplastic resin or the thermosetting resin is attached to the edge along the end of the edge, and the other half width of the tape is attached to the face forming the groove.

5. The pouch-type lithium secondary battery with improved safety of claim 1, wherein the pouch forms a square when viewed from the thickness direction of the groove; the edges of the both two sides of the pouch are primarily bent in half width to be overlapped each other; the overlapped edges are secondarily bent again to the groove direction; and the flame retardant and heat resistant resin composition prepared by mixing the flame retardant material and the heat resistant material to the thermoplastic resin or the thermosetting resin only covers one side where a protective circuit substrate is installed and the edge end of the two edge where the two sides meet.

6. The pouch-type lithium secondary battery with improved safety of claim 1, wherein the flame retardant material is one or a mixture of more than two selected from a group consisting of halogen-based flame retardant, phosphorous-based flame retardant, nitrogen-based flame retardant and inorganic compound flame retardant.

7. The pouch-type lithium secondary battery with improved safety of claim 6, wherein the halogen-based flame retardant is one or a mixture of more than two selected from a group consisting of tribromophenoxyethane, tetrabromobisphenol-A (TBBA), octabromodiphenylether (OBDPE), brominated expoxy, brominated polycarbonate oligomer, chlorinated paraffin, chlorinated polyethylene and cycloaliphatic chlorinated flame retardant.

8. The pouch-type lithium secondary battery with improved safety of claim 6, wherein the phosphorous-based flame retardant is one or a mixture of more than two selected from the group consisting of phosphates, phosphine oxide, phosphine oxide diols, phosphites, phosphonates, triarylphosphate, alkyldiarylphosphate, trialkylphosphate and resorcinol bis(diphenylphosphate) (RDP).

9. The pouch-type lithium secondary battery with improved safety of claim 6, wherein the nitrogen-based flame retardant is one or a mixture of more than two selected from a group consisting of melamine, melamine phosphate and melamine cyanurate.

10. The pouch-type lithium secondary battery with improved safety of claim 6, wherein the inorganic compound flame retardant is one or a mixture of more than two selected from a group consisting of aluminum hydroxide, magnesium hydroxide, antimony oxide, tin hydroxide, tin oxide, molybdenum oxide, zirconium compound, borate and calcium salt.

11. The pouch-type lithium secondary battery with improved safety of claim 6, wherein the heat resistant material is copper-based heat resistant or phosphite-based heat resistant.

12. The pouch-type lithium secondary battery with improved safety of claim 11, wherein the phosphite-based heat resistant is selected from a group consisting of bis(2,6-di-tert-butyl-4-methylphenyl)pentaerythritol-di-phosphite, tetrakis[methylene-3-(laurylthio)propionate]methane, triphenylphosphite, trilaurylphosphite, tris(nonylphenyl)phosphite, tri-iso-octyl-phosphite, trioleylphosphite, tris(2,4-di-tert-butylphenyl)phosphite, diphenyl-nonylphenyl-phosphite, phenyl-di-isodecyl-phosphite and trilauryl-tri-thio-phosphite.

13. The pouch-type lithium secondary battery with improved safety of claim 1, wherein the secondary battery is a lithium ion battery or a lithium polymer battery.

14. A middle or large-sized battery pack comprising one or more than two of the pouch-type lithium secondary batteries of claim 1.

15. The middle or large-sized battery pack of claim 14, wherein at least a part of or entire unit cells is connected in series, and one or more than two of the unit cells connected in series is composed of the pouch-type lithium secondary battery.
